(19) United States
(12) Patent Application Publication
(10) Pub. No.: US 2011/0106775 A1
(43) Pub. Date: May 5, 2011

(54) METHOD AND APPARATUS FOR MANAGING MULTIPLE DOCUMENT VERSIONS IN A LARGE SCALE DOCUMENT REPOSITORY

(75) Inventors: James Arbo, Chelmsford, MA (US); Michael J. Cronin, Swampscott, MA (US); Keith Meyer, Southborough, MA (US); Daniel J. Murphy, Boxford, MA (US)

(73) Assignee: Copyright Clearance Center, Inc., Danvers, MA (US)

(21) Appl. No.: 12/610,894

(22) Filed: Nov. 2, 2009

(51) Int. Cl. G06F 17/30

(52) U.S. Cl. 707/695; 707/737; 707/E17.014

(57) ABSTRACT

In a large scale data repository, a single logical view of multiple versions of the same data is presented. In order to determine which data versions are equivalent without comparing each pair of entries in the database, the database entries are clustered with a clustering algorithm and then comparisons between entries are made only between the entries in each cluster. Once a set of entries has been determined to be equivalent, a composite master entry is constructed from those entries in the set that contain preferred metadata and the composite master entry is made available for searches and display to the user.

### BACKGROUND

This invention relates to library services and methods and apparatus for maintaining a database of content location and reuse rights for that content. Works, or “content”, created by an author is generally subject to legal restrictions on reuse. For example, most content is protected by copyright. In order to conform to copyright law, content users often obtain content reuse licenses. A content reuse license is actually a “bundle” of rights, including rights to present the content in different formats, rights to reproduce the content in different formats, rights to produce derivative works, etc. Thus, depending on a particular reuse, a specific license to that reuse may have to be obtained.

Many organizations use content for a variety of purposes, including research and knowledge work. These organizations obtain that content through many channels, including purchasing content directly from publishers and purchasing content via subscriptions from subscription resellers. In these latter cases, reuse licenses are provided by the publishers or resellers. However, in many other cases, users must search to discover the location of content. In order to insure that their use is properly licensed, these organizations often engage the services of a license clearinghouse in order to locate the content and obtain any required reuse license.

The license clearinghouse, in turn, maintains a database of metadata that references the content and, in some cases, maintains copies of the content itself. The metadata indicates where the content can be obtained and the license rights that are available. With this database, a user can search for metadata that references the desired content, select a location for obtaining the content and pay a license fee to the license clearinghouse to obtain the appropriate reuse license. The user then obtains the content from the selected location and the license clearinghouse distributes the collected license fee to the proper parties.

In order to keep the metadata database current, license clearinghouses constantly receive new metadata and content material from several different sources, such as the Library of Congress, the Online Computer Library Center (OCLC), the British Library or various content publishers. Often, metadata that references to the same content is obtained from several different sources.

In addition, even though some metadata is equivalent in the sense that it references the same content, certain metadata may be preferred. For example, metadata that references content which is available from the license clearinghouse and for which licenses are also available from the content clearinghouse, is preferred over metadata that references content where the license must be obtained from a third party. Some sources, such as the Library of Congress, the British Library or OCLC are considered authoritative and thus metadata that reference content in these sources is preferred over metadata that references content that can be obtained from other sources, such as publishers.

It is desirable to provide the most preferred metadata to a user who is searching the database. Thus, the database metadata entries must be compared with each other to determine which entries will be returned as the results of a search. While a method using straightforward comparison can be successful with relatively small databases, it quickly becomes prohibitively time-consuming with large scale databases. For example, if the metadata representing every work is compared to the metadata representing every other work in the database, for a database with n works, the number of combinations is n*(n−1)/2. Therefore, for a database containing 25 million works, 312.5 trillion comparisons are required to determine the preferred database entries. Similarly, for a database with 75 million works, 2.8125 quadrillion comparisons are required.

Consequently, some mechanism is required that manages different versions of a work so that a most preferred version is presented to a user and new material can be entered within a reasonable time.

### SUMMARY

In accordance with the principles of the invention, the database entries are clustered with a clustering algorithm and then comparisons between entries are made only between the entries in each cluster. Once a set of entries has been determined to be equivalent, the entry with the most preferred metadata is marked as preferred so that it is indexed and displayed as the result of a search. When an entry must be edited or when license rights must be assigned to an entry, a composite master entry is constructed from those entries in the set that contain preferred metadata and stored in the database. The composite master entry is then marked as the preferred data entry so that it is subsequently made available for searches and display to the user.

In one embodiment, data entries that are determined to be equivalent are assigned the same publication ID and stored in the database. Later, when a master entry is required, all entries with publication IDs that are the same as that entry are retrieved and the master entry is constructed from the retrieved entries.

In another embodiment, equivalent entries are ranked by a quality level that is based on the publication source. Fields in the master entry are filled with corresponding data available in the data entry with the highest quality level. For fields that remain unfilled because no corresponding data is available in the data entry with the highest quality level, if corresponding data is available in the data entry with the next highest quality level, that data may be used to fill these fields.

In still another embodiment, the master field filling process is continued until a predetermined required number of fields are filled.

In yet another embodiment, the master field filling process is continued until as many fields are filled as possible.

### BRIEF DESCRIPTION OF THE DRAWINGS

FIG. 1 is a flowchart showing the steps in an illustrative process for loading new data entries representing works into a works repository.

FIG. 2 is a flowchart showing the steps in an illustrative process for reading data records from a library catalog and entering the data records into a staging database.

FIG. 3 is a block schematic diagram showing selected apparatus for the process of FIG. 2.

FIG. 4 is a flowchart showing the steps in an illustrative process for validating data records in the staging database.

FIG. 5 is a block schematic diagram showing selected apparatus for the process of FIG. 4.

FIG. 6 is a flowchart showing the steps in an illustrative process for equivalence matching of data records in the staging and repository databases.

FIG. 7 is a block schematic diagram showing selected apparatus for the process of FIG. 6.

FIG. 8 is a flowchart illustrating the steps in constructing a master entry.

FIG. 9 is a block schematic diagram illustrating the storing and processing of data records in the repository database.

### DETAILED DESCRIPTION

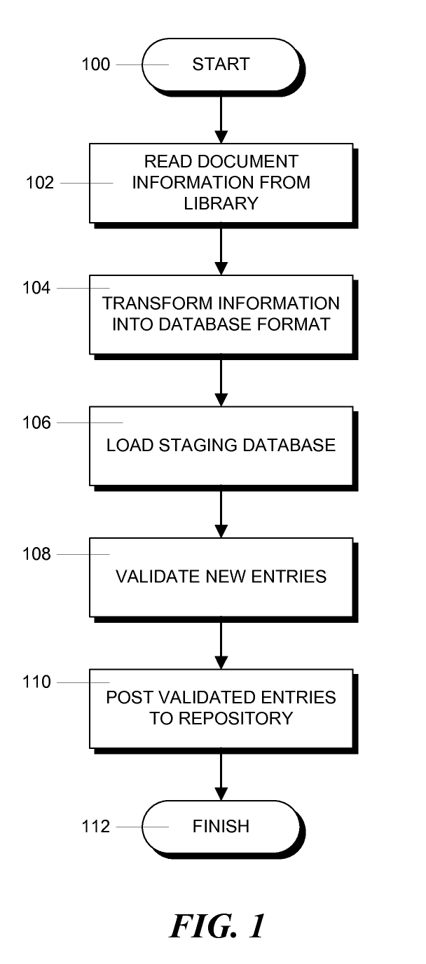

FIG. 1 shows the steps in an illustrative process for loading a document repository from a document source, such as a library. This process begins in step 100 and proceeds to step 102 where document information is read from a library or a library catalog. This information is typically bibliographic information in a format specific to a particular library or one of several standard formats such as ONIX or MARC. Since there is currently no one universal standard, data in any incoming format is first transformed into a single intermediate format. Consequently, in step 104, the information is transformed into a format suitable for loading into a staging database. Next, in step 106, the information is loaded into a staging database where it can be processed for validation. In step 108, new entries are validated.

Bibliographic data entries can come from many sources and each source has its own data format. In many cases, the same data comes from multiple sources. In the inventive system, all data that is loaded is stored in association with its source. Each source and the data entries associated with that source have assigned to them a “quality” level chosen from a predetermined hierarchy. As mentioned above, the highest quality is assigned to sources/data entries that reference content which is available from the license clearinghouse and for which licenses are also available. The next hierarchy levels are assigned to sources which are considered authoritative, such as the Library of Congress and the British Library. The lowest levels in the hierarchy are assigned to other sources, such as publishers.

The validation process, which is discussed in more detail below, entails processing each entry into a standard form and checking for duplicate entries. The validated entries are then posted to the document repository in step 110 and the process finishes in step 112. Then, as described below, for each unique record, either the highest quality version or a composite entry created from information in equivalent entries is produced as the results of a search or in an index.

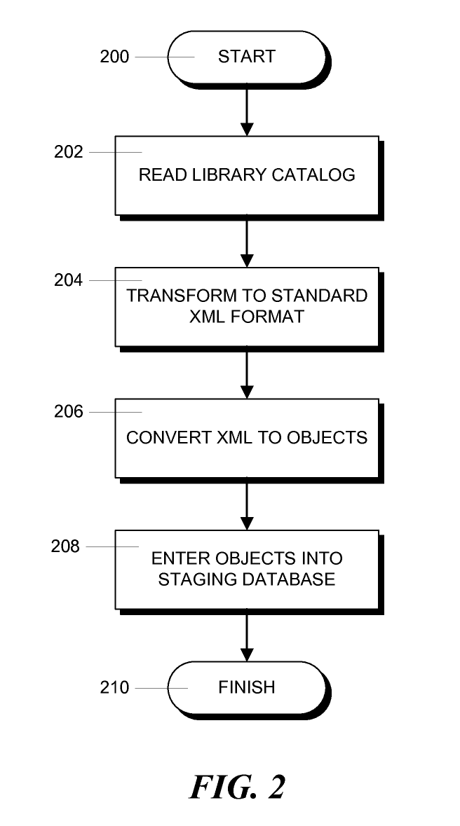

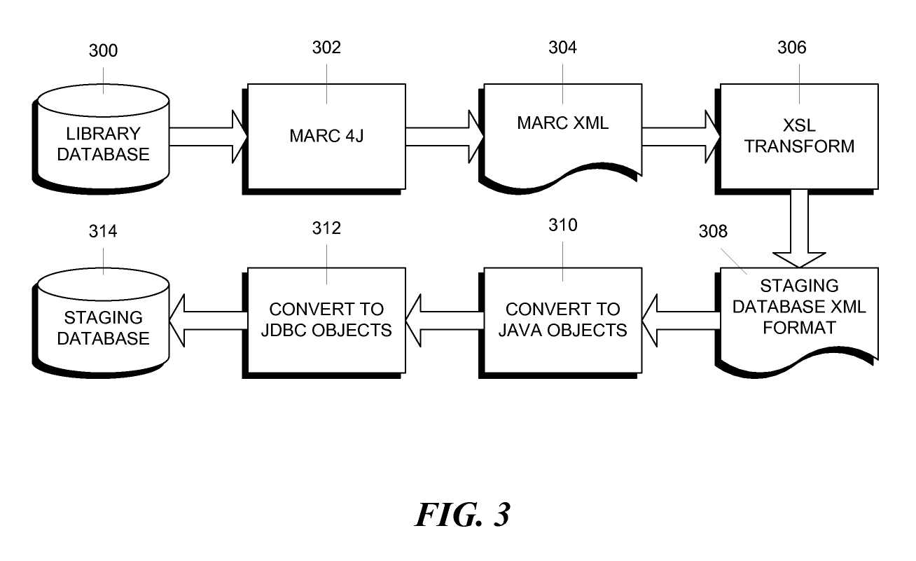

FIGS. 2 and 3 show in more detail the steps in an illustrative process for reading information from a library database 300, converting the information and loading the converted information into the staging database 314. Note that although two separate databases 300 and 314 are illustrated, the staging database 300 and the repository database 314 could be two areas of a single database. In this illustration, the Library of Congress is used as an example of a source; similar steps would be used to read information from other sources. This process begins with step 200 and proceeds to step 202 where the library database 300 is read with suitable software, such as MARC 4J (302). MARC 4J is an open source software library for working with MAchine Readable Cataloging (MARC). The MARC 4J software library has built-in support for reading MARC and generating MARC XML data 304. MARC XML is a simple XML schema for MARC data published by the Library of Congress.

Next, in step 204, the MARC XML data is transformed to an XML format 308 that is used in the staging database 314. As indicated in FIG. 3, this transformation might be performed with a conventional transform language 306, such as XSL. In step 206, the XML data 308 is converted into Java objects. This step can be performed using an XML data binding framework 310, such as CASTOR. Depending on the staging database, the CASTOR objects can be converted to JDBC objects using a framework 312 that couples objects with stored procedures or SQL statements using a XML descriptor, such as iBATIS. In step 208, the objects are entered into the staging database 314 as new data entries and the process finishes in step 210. Although processing is illustrated in FIGS. 2 and 3 for only the MARC data format. Other formats, such as ONIX, are commonly used and are processed in a similar manner.

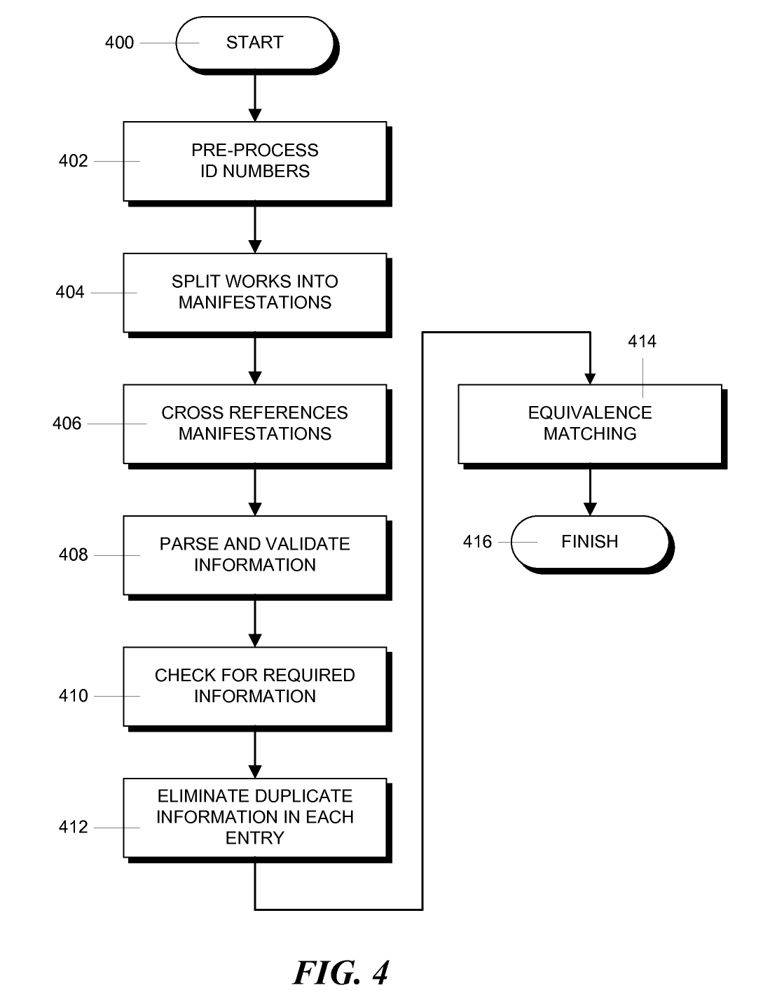

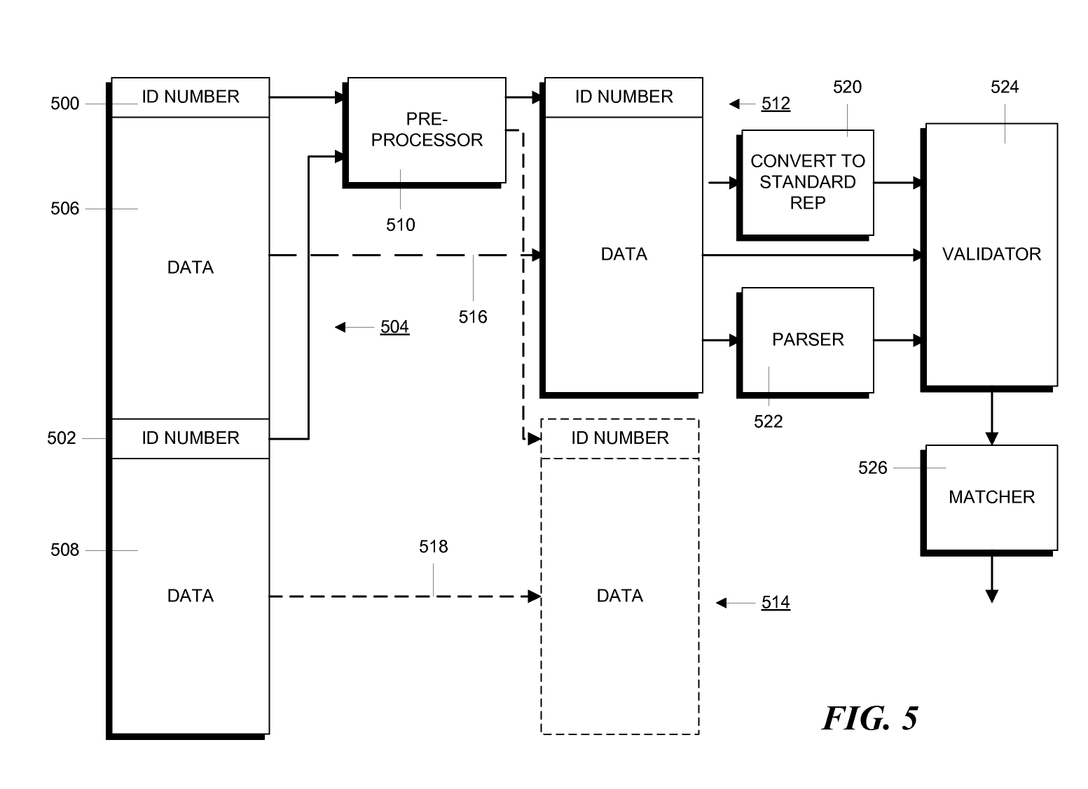

FIGS. 4 and 5 illustrate in more detail the processing step 108 (shown in FIG. 1) of validating each new data entry. As shown in FIG. 4, this process begins in step 400 and proceeds to step 402 where identification numbers 500 and 502 associated with the data entry 504 are pre-processed in pre-processor 510. In this step, all of the data values that could potentially be ID numbers are examined. For each potential ID number, extraneous punctuation is removed, the data is trimmed, and the data is processed by a check routine to determine if it is a valid ID number. Depending on the type of ID number, the check routine is different and for some ID types no check routine is available. For example, ID numbers which follow an ISBN-10 format use a modulus-11 checksum routine, while ISBN-13 format ID numbers use a modulus-10 checksum routine. CODEN, ISMN, SICI and other ID number formats all have different check routines. For some ID number types, the punctuation is checked and corrected, if necessary. Missing ISBN-10 and ISBN-13 ID numbers are generated where a counterpart should exist. The processed ID number is then stored in a field in the new data entry. In some cases, where additional processing of the “raw” data may be necessary, the raw data may also be stored in another field of the new data entry.

In addition, data records occasionally represent more than one version or “manifestation” of a single work. In the inventive system, metadata representing each manifestation is stored because a manifestation is the level at which copyright is assigned. Consequently, in step 404, when data containing more than one ID number of the same type in a single record is received from a source, it represents more than one manifestation, so that record is split into multiple manifestations. This is illustrated in FIG. 5 wherein data record 504 is split into manifestation data records 512 and 514 as indicated by arrows 516 and 518, respectively. Each split entry is marked by a flag stored in a field of the entry indicating that it is a split entry.

The data in each data record is now further processed. In FIG. 5, this processing is shown only for data record 512 for clarity. However, those skilled in the art would understand that each record in processed in the same manner. In step 406, each data field is examined and different representations of the same concept are converted into standard representations using a conventional table lookup procedure. This is necessary because different sources use different values to represent the same languages, countries, ID number types, title types, and other values. For example, all values representing a particular language are converted to a single standard value representing that language. This is performed by the converter 520. The converted value is then stored in an appropriate field of the new data entry.

In parsing and validation step 408, other, more complex, data values that sources represent in various ways are normalized. A simple example is a publication date. Dates can be represented in a wide variety of ways, so the publication date is extracted by parsing the entry, and converted into a single format. This parsing is performed by the parser 522 and the exact form of the parsing depends on the source and the format of the data entry. In general, all date fields are subjected to this kind of processing, including author birth date and author death date. Similarly, the technique for representing the page count of a work also varies widely among sources, and even within each source, so the page numbers must be parsed out of the data entry and normalized into a standard format by parser 522. These converted values are also stored.

Validation involves examining the data to insure that it is readable and falls within certain limits. For example, certain characters, such as control characters, that might cause readability problems are removed from the data fields. Checks are also made to determine that the data will fit into its assigned location in the repository, that the data type is correct, and the data value is not too large. Some data fields (for example, date fields) are range checked to make sure they are within a reasonable range. Certain data tables in the repository database require entries in selected rows (for example, titles). The existence of the required data in the staging database is checked in step 410. Finally, in step 412, duplicate data is eliminated from each data entry. This processing is performed by the validator 524.

The data records in the staging database each have a fixed format with predetermined fields which accept data. Some or all of the fields may contain data as a result of the processing described above in connection with FIGS. 1-4. These data fields include information such as, but not limited to, the publication source, the publication type, the publication start and end dates, the publication edition, the publication ID number, start and end page and format and the copyright year. The data entry may also contain various processing flags, such as flags indicating whether the entry is the preferred entry, a master entry and a split entry, and the quality level associated with the source. In many cases, the data in a particular field may be a reference to the actual data contained in another table or a data entry ID may be used to access data in other tables as is well-known in the art.

In step 414, a matching routine is run by the matcher 526 to determine whether the new data entry is “equivalent” to one or more data entries already stored in the repository. This routine is executed each time a new data entry is loaded into the staging database as indicated in step 414. However, it may also be executed when existing data entries are edited. In this manner equivalence is always determined. When a new data entry is received from a source, a decision must first be made whether to add the new entry or to update an existing entry already in the repository database. Where possible, a key value assigned by the source is used to make this determination. If the key value of the received data entry differs from the key values of data entries already stored in the repository database, then the received entry is assumed to be a new entry, otherwise an existing entry is updated. Where it is not possible to use the key value, the equivalence routine is run on the data entries associated with the source in the repository database to determine whether the received entry is new or equivalent to an existing entry.

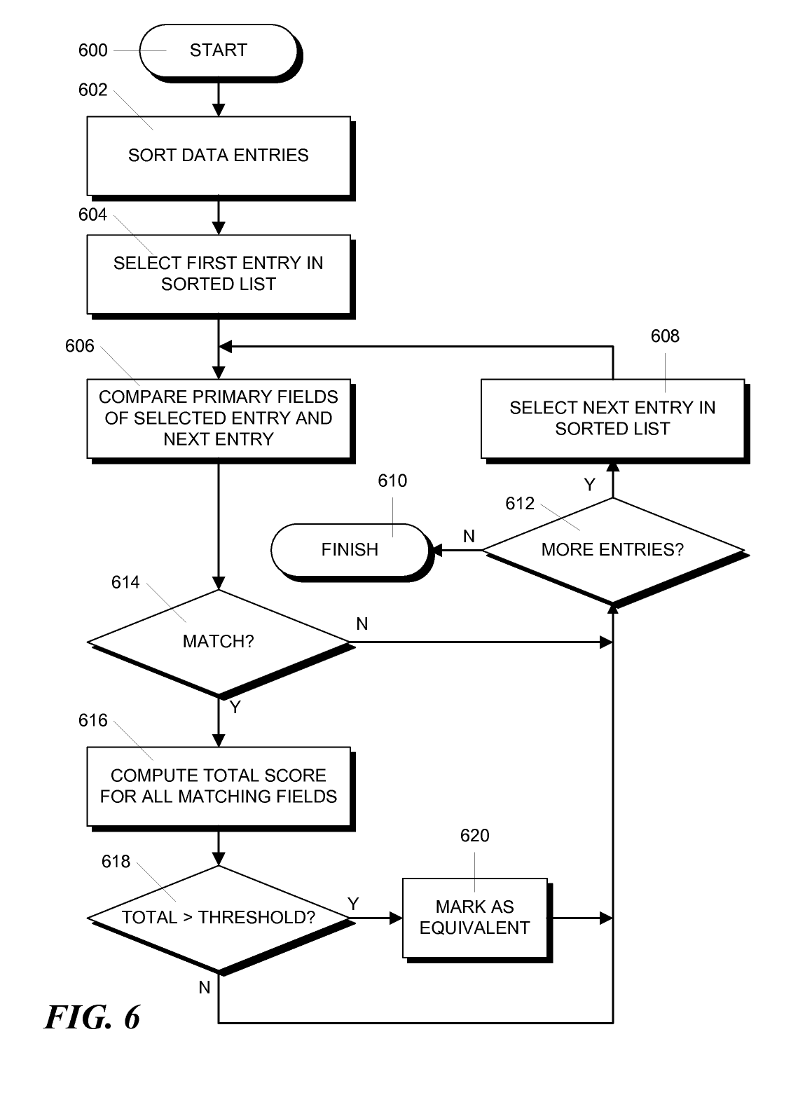

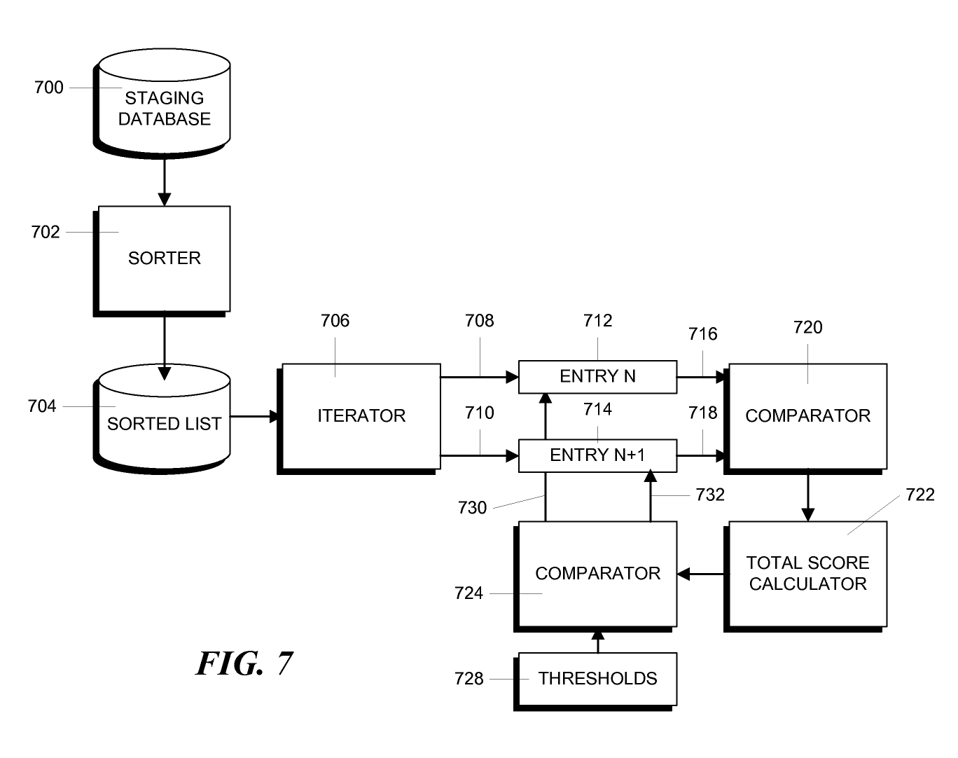

As mentioned above, due to the large number of data entries in the repository database, it is not possible to compare the data in the fields of each new data entry to corresponding data in the fields of each existing data entry in order to make a determination of equivalency. Instead, in accordance with the principles of the invention, a clustering method is used to make the equivalency determination. One illustrative embodiment is shown in FIGS. 6 and 7. Those skilled in the art would understand that other systems may also be used. Initially, a scoring system is used to assign a predetermined numeric point weight to each match that occurs between data values in a selected field in two different data entries. For example, 600 points could be assigned to an exact match between the titles in two different entries. Similarly, a match of ID numbers might be assigned 200 points, a match of page count might be assigned 200 points and a match of author names might be assigned 100 points. The scoring system methodology in one embodiment of the invention is based on a scoring system developed and used in the MELVYL Recommender Project and is described in more detail at the website: cdlib.org/inside/projects/melvyl_recommender/report_docs/mellon_extension.pdf. The values listed above have been substituted from those actually used in the MELVYL project. Those skilled in the art would understand that other point systems could be easily substituted without departing from the principles of the invention.

As shown in FIG. 6, the process then begins in step 600 and proceeds to step 602 where the list of data entries to be clustered is sorted by the sorter 702. The entries are sorted by the data field to which the highest score has been assigned (called the “primary” data field) and then by the data field to which the next highest score has been assigned. The sorting procedure produces a sorted list 704. An iterator 706 then proceeds through the sorted list entry by entry. The iterator 706 begins by selecting (schematically illustrated by arrows 708 and 710) the first two entries (schematically illustrated as entries 712 and 714) in the sorted list 704 as indicated in step 604.

The data values in the primary data field are then extracted, as indicated by arrows 716 and 718, and applied to comparator 720 which compares the values as indicated in step 606. If the data values match as determined in step 614, the process proceeds to step 616 where a score calculator 722 calculates a total score for the pair of entries. The total score is calculated by examining, in both entries, each data field to which a match score has been assigned. When the data field values match, the assigned match score is added to the total score. If the values do not match, nothing is added to the total score. After the total score has been calculated, it is provided to a comparator 724 as indicated by arrow 726.

The comparator compares the total score to various predetermined thresholds 728. When the total score exceeds a predetermined equivalence threshold value (for example, 875), the pair of data entries are deemed equivalent. Similarly, if the total score exceeds a predetermined near-equivalence score (for example 675), the pair of entries are deemed to be near-equivalent.

Equivalent entries are marked by assigning to them the same publication ID, as set forth in step 620 and as indicated schematically by arrows 730 and 732 in FIG. 7. Near-equivalent entries may occur because of the clustering process which produces “false positive” results in which two entries that are in fact different are deemed to be equivalent and “false negatives” in which two entries that are in fact equivalent are deemed to be not equivalent. False positive and false negative results can be handled in several different ways. One way is to present the entries which are deemed to be near-equivalents to a user for a manual review. The user can then deem the entry as to be equivalent or not equivalent by reviewing all of the data fields. Alternatively, all data fields for the two entries can be compared for exact matches to determine equivalence. Other methods include changing the threshold required for equivalence or using a different mechanism to compute equivalence for the two entries.

The exemplary clustering method is effective for bibliographic data entries. One skilled in the art would understand that other conventional clustering algorithms, such as dimensional reduction, can also be used. If information other than bibliographic information is included in the entries, then algorithms, such as latent semantic indexing, can be used as would be known to those skilled in the art.

After the entries have been marked or, alternatively, if no match is determined in step 614 or the total score is determined to be less than the near-equivalence threshold in step 618, the process proceeds to step 612 where a determination is made whether additional entries remain to be processed. If no entries remain to be processed, then the process finishes in step 610.

Alternatively, if in step 612, it is determined that additional entries remain to be processed, then the process proceeds to step 608 where the next entry is selected for processing and the process proceeds back to step 606. In this manner, all pairs of entries in the sorted list are compared for equivalence.

When data entries are indexed, such as in connection with a search function, equivalents to a data entry are examined and the entry with the highest quality is selected. If two entries are equivalent and have the same quality level assigned, then both entries are indexed together. Highest quality entries are marked as preferred so that they will be displayed in search results. If a data entry with a higher quality level is later loaded into the repository database, that entry is then marked as preferred.

However, in one embodiment, when a entry is “used” in the sense that it must edited or license rights are to be assigned to the underlying work, all entries equivalent to that entry are examined and a “master” entry is created and marked as equivalent to the other data entries by giving it the same publication ID. This master entry is then assigned the highest quality level that is available and is also marked as a preferred entry. Master entries are the only entries in the repository that are editable. When a user attempts to change a data entry that has no corresponding master entry, a new master entry is created from the entry and the user is allowed to edit the new master entry instead. The new master entry then is marked as preferred. In this manner, the inventive system presents a single logical view of the data because data entries in the repository that are equivalent to data entries with higher quality levels are hidden and never presented to a user. In another embodiment, the master entry is created at the time when the equivalent entries are determined.

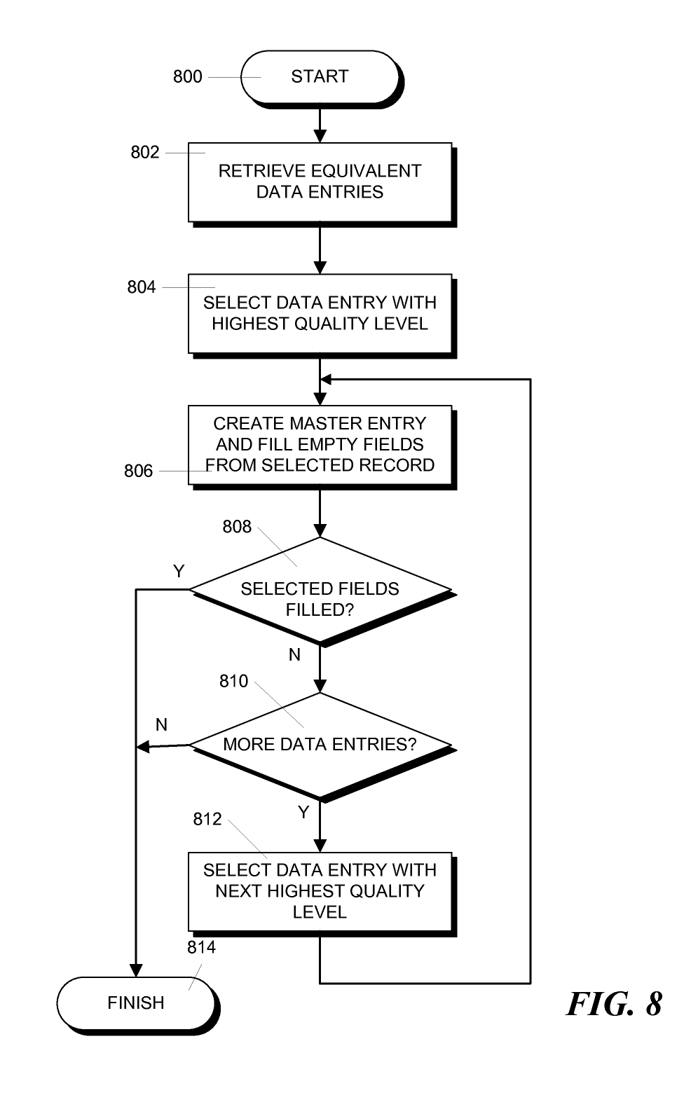

FIG. 8 shows the steps in an illustrative process for creating a master entry for a plurality of equivalent data entries. This process begins in step 800 and proceeds to step 802 where data entries that are equivalent to the data entry, which is being “used”, are retrieved from the repository. As previously mentioned, these entries will have the same publication ID as the used entry and can be retrieved by using an index created from the publication ID. Next, in step 804, the data entry with the highest quality level among the equivalent data entries is selected by examining the quality level field. In step 806, a master entry is created and the fields in the master entry are filled with data from the corresponding fields in the selected data entry. In one embodiment, only selected fields are designated to be filled with data. In another embodiment, all fields are selected to be filled with data. In either case, a determination is made in step 808 whether all selected fields have been filled with data.

If, in step 808, it is determined that all selected fields have been filed with data, then the process finishes in step 814. Alternatively, if it is determined in step 808 that all selected fields have not been filled, then the process proceeds to step 810 where a determination is made whether there are more data entries to be examined.

If in step 810 it is determined that no additional data entries remain to be examined, then all selected data fields in the master entry for which information is

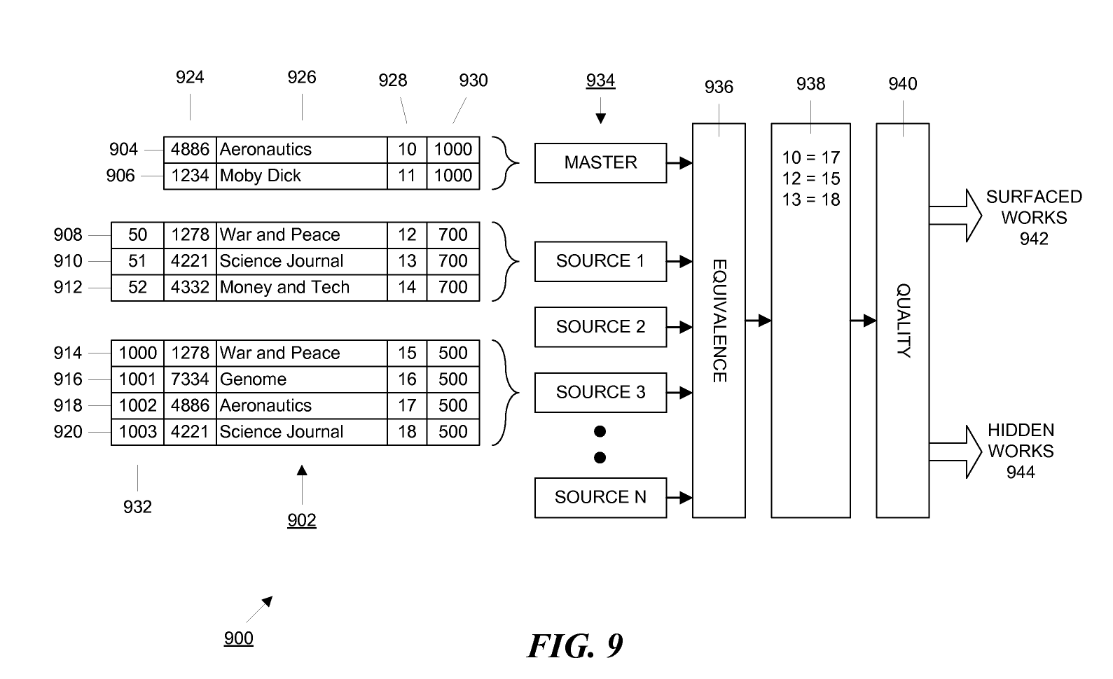

This data entry arrangement 900 is shown schematically in FIG. 9. On the left side of the figure are a set of entries 902 that are maintained in the repository. Each entry, such as entry 904, contains various data fields, of which four or five are shown. For example, entry 904 has an ID number field 904, a title field 906, an entry number field 908 and a quality field 910. In addition, many sources also include a key field 912, which holds a key number which, as previously mentioned, is assigned by the source to each entry, such as entries 908-920.

Each of entries 902 is associated with a source that generated the entry. As previously mentioned, the sources are arranged in a predetermined hierarchy by quality. For example, entries 904 and 906 are master entries created as described above. These entries have the highest quality level 930 (illustratively designated as 1000 in the example shown in FIG. 9.) Similarly, entries 908-912 are associated with source 1 and have a lower quality level of 700. Entries 914-920 are associated with source 3 and have an even lower quality level of 500. Other entries which are not shown may have different quality levels associated with their sources. All of the entries are arranged in the hierarchy 934 by source.

All of the entries are also subject to equivalency processing, schematically illustrated by block 936 which generates an equivalency list 938 that is also stored in the repository. As indicated in list 938, in the illustration, work number 10 is equivalent to work number 17; work number 12 is equivalent to work number 15 and work number 13 is equivalent to work number 18.

Lastly, the entries are subjected to a quality check so that only the highest quality unique entries are selected for display to the user. These works 942 are surfaced to the user whereas other works 944 that are equivalent to the highest quality

| Work | ID Number | Title |
|---|---|---|
| 10 | 4885 | Aeronautics |
| 11 | 1234 | Moby Dick |
| 12 | 1278 | War and Peace |
| 13 | 4221 | Science Journal |
| 14 | 4332 | Money & Tech |
| 16 | 7334 | Genome |

Whereas the following works would be hidden:

| Work | ID Number | Title |
|---|---|---|
| 15 | 1278 | War and Peace |
| 17 | 4886 | Aeronautics |
| 18 | 4221 | Science Journal |

While the invention has been shown and described with reference to a number of embodiments thereof, it will be recognized by those skilled in the art that various changes in form and detail may be made herein without departing from the spirit and scope of the invention as defined by the appended claims.

What is claimed is:

1. A computer-implemented method for displaying a single logical view of multiple document versions in a large scale document repository storage, comprising:
(a) representing each document version with a separate data entry, each data entry having a fixed number of data fields and being stored in the repository storage;
(b) assigning each data entry a quality level based on a source that generated the data entry;
(c) creating sets of equivalent data entries by comparing data fields of pairs of data entries; and
(d) creating a master entry from at least one set of equivalent data entries by creating a blank data entry in the repository storage and filling data fields in the blank entry with data taken from the data entries in the set starting with the data entry having the highest quality level and, for unfilled data fields, proceeding to examine data entries with lower quality levels.

2. The method of claim 1 wherein step (d) is performed when a data entry in the set of equivalent data entries must be edited.

3. The method of claim 2 wherein the step (d) is performed and then the master entry is made available for editing instead of a data entry in the set of equivalent entries.

4. The method of claim 1 wherein step (d) is performed when license rights must be assigned to a data entry in the set of equivalent data entries.

5. The method of claim 4 wherein the step (d) is performed and then license rights are assigned to the master entry instead of a data entry in the set of equivalent entries.

6. The method of claim 1 wherein step (d) comprises filling only pre-selected data fields in the blank entry by sequentially examining data entries in the set until either the pre-selected data fields have been filled or all data entries in the set have been examined.

7. The method of claim 1 wherein step (d) comprises filling data fields in the blank entry by sequentially examining data entries in the set until either all data fields have been filled or all data entries in the set have been examined.

8. The method of claim 1 wherein step (c) comprises:
(c1) clustering the database entries with a clustering algorithm and for each cluster, comparing at least one data field of each entry in that cluster; and
(c2) marking as equivalent in the repository storage data entries in a cluster that are determined to be equivalent by the comparison in step (c1).

9. The method of claim 1 wherein, in step (c), data field values are normalized prior to comparison.

10. The method of claim 1 wherein each data entry comprises a preferred flag and wherein the method further comprises for each set of equivalent data entries, setting the preferred flag of the data entry with the highest quality level to indicate that when one of the data entries in the set is selected during a search, the data entry in the set whose flag is set is presented for display instead of the selected data entry.

11. The method of claim 10 wherein step (d) comprises setting the preferred flag in the master data entry to indicate that when one of the data entries in the set is selected during a search, the master data entry is presented for display and clearing the preferred flag in the data entry whose flag had previously been set.
